(19) United States
(12) Patent Application Publication
(10) Pub. No.: US 2023/0277879 A1
(43) Pub. Date: Sep. 7, 2023

(54) Fire Shelter Apparatus and Method

(71) Applicant: O'KEEFFE'S, INC., Brisbane, CA (US)

(72) Inventor: William F O’Keeffe, Brisbane, CA (US)

(73) Assignee: O'KEEFFE'S, INC., BRISBANE, CA (US)

(21) Appl. No.: 18/197,042

(22) Filed: May 13, 2023

Related U.S. Application Data
(63) Continuation-in-part of application No. 17/978,926, filed on Nov. 1, 2022, now abandoned.
(60) Provisional application No. 63/274,881, filed on Nov. 2, 2021.

(51) Int. Cl. A62C 2/06; A62C 99/00

(52) U.S. Cl. CPC A62C 2/06; A62C 99/0009

(57) ABSTRACT

A portable fire shelter that utilizes an absorbent layer that is impregnated with a fire resistant liquid or gel. The fire shelter is packaged in a way that prevents the liquid or gel from evaporating or hardening. The fire shelter can be transported to the fire zone using robots or drones, and when deployed the fire shelter provides an interior space that maintains a temperature of less than 200° F. in a fire environment that can reach hundreds, or more than a thousand, degrees F for a period sufficient to protect an object or a person until the fire blows by.

### CROSS-REFERENCES TO RELATED APPLICATIONS

This application is a continuation-in-part of U.S. Pat. Application Serial No. 17/978,926 filed on Nov. 1, 2022, which claims the benefit of U.S. Provisional Pat. Application serial number 63/274,881 filed on Nov. 2, 2021, both incorporated herein by reference.

### BACKGROUND

Fire shelters are employed by firefighters in an emergency situation to protect them from flames and heat emanating from a fire, such as a rapidly spreading wildfire. Normally, fire blankets or fire shelters are carried by fire fighters during firefighting activities.

Unfortunately, prior art fire blankets or fire shelters have been unsuccessful in protecting fire fighters during fire storm conditions. Such failure is due to various inadequacies of the prior art, including the inability of prior art fire shelters to prevent the passage of heat through the shelter over relatively short periods of time. The tragic result of such failure has cost lives of the fire fighters. Lives could be saved by a fire shelter that protected firefighters and others for periods of up to 15 minutes or more from dangerous temperatures at or over 200° F.

### SUMMARY

In accordance with the present invention a novel and useful fire shelter material is herein provided.

The shelter is primarily comprised of a base material that utilizes at least one layer of suitable absorbent material saturated with a heat-resistant material that retards heat transfer. The shelter can include additional materials, such as one or more additional layers or outer treatments having heat reflective characteristics. Most notably, the absorbent base layer is impregnated with a fire retardant chemical, that greatly increases the protection afforded by the combination of layers in the presence of a flame, over a sustained period of time.

Provided are a plurality of example embodiments, including, but not limited to a portable fire shelter comprising: a layer of absorbent material; and a fire resistant substance impregnating said layer of absorbent material, wherein said fire shelter is configured to deploy in a manner to form an interior space that is protected from exceeding 200° F. for at least 15 minutes when said fire shelter is deployed in a fire environment.

Also provided is a portable fire shelter comprising: a layer of absorbent material; a fire resistant substance in the form of a liquid or gel impregnating said layer of absorbent material; and packaging configured to prevent said fire resistant substance from evaporating from, or hardening within, said layer of absorbent material after said impregnating, wherein said fire shelter is configured to deploy in a manner to form an interior space that protects an object or person provided in the interior space from excessive heat when said fire shelter is deployed in a fire environment.

Still further provided are any of the above portable fire shelters further comprising a deployment structure configured to attach said shelter in said packaging to a drone aircraft.

Also provided are any of the above portable fire shelters having packaging configured to be consumed, melt, or otherwise be opened by action of the heat of said fire environment.

Further provided are any of the above portable fire shelters that are configured to automatically deploy said fires shelter in said fire environment.

Still further provided are any of the above portable fire shelters that are deployed by a method including a robot or drone to deliver said fire shelter to said fire environment.

Also provided is method of providing a protected interior space in a fire environment, comprising the steps of:
providing a fire shelter comprising: a layer of absorbent material, a fire resistant substance in the form of a liquid or gel impregnating said layer of absorbent material, and packaging configured to prevent said fire resistant substance from evaporating from, or hardening within, said layer of absorbent material after said impregnating;
transporting said fire shelter to a fire zone;
deploying said fire shelter in said fire zone to provide a protected space; and
maintaining a temperature within said protected space of less than 200° F. for at least 15 minutes in said fire zone.

Also provided are additional example embodiments, some, but not all of which, are described hereinbelow in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1 is a sectional view of an example embodiment of the fire shelter material having a base layer impregnated with a fire resistant material.

FIG. 2 is a sectional view of another example embodiment of the fire shelter material of the present invention having the base layer impregnated with a fire resistant material and additional layers.

FIG. 2A is a sectional view adding an additional outer layer to the example embodiment of FIG. 2.

FIG. 3A is a schematic view showing an example embodiment of a packaged and sealed fire shelter ready for deployment.

FIG. 3B is a schematic view showing another example embodiment of a packaged and sealed fire shelter that can be automatically deployed ready for deployment.

FIG. 4 is a schematic view showing the example embodiment of FIG. 3A being carried by a flying drone for deployment into a fire location.

FIG. 5 is a schematic view showing an example protection deployment for protecting a person.

FIG. 6 is a schematic view showing another example protection deployment for protecting a building.

FIG. 7 is a schematic view showing another example protection deployment for protecting a vehicle.

FIG. 8 is a schematic view of an example testing apparatus used to test one or more of the example embodiments of the invention.

FIG. 9 is a graph of a first test representing the heat penetration from a flame on an example embodiment of the fire retardant material of the present invention, over time.

FIG. 10 is a graph of a second test of the impregnated felt of the example embodiment of the present invention against heat penetration, over time.

### DETAILED DESCRIPTION OF THE EXAMPLE EMBODIMENTS

Various aspects of the present invention will evolve from the following detailed description of the preferred embodiments thereof which should be referenced to the prior described drawings.

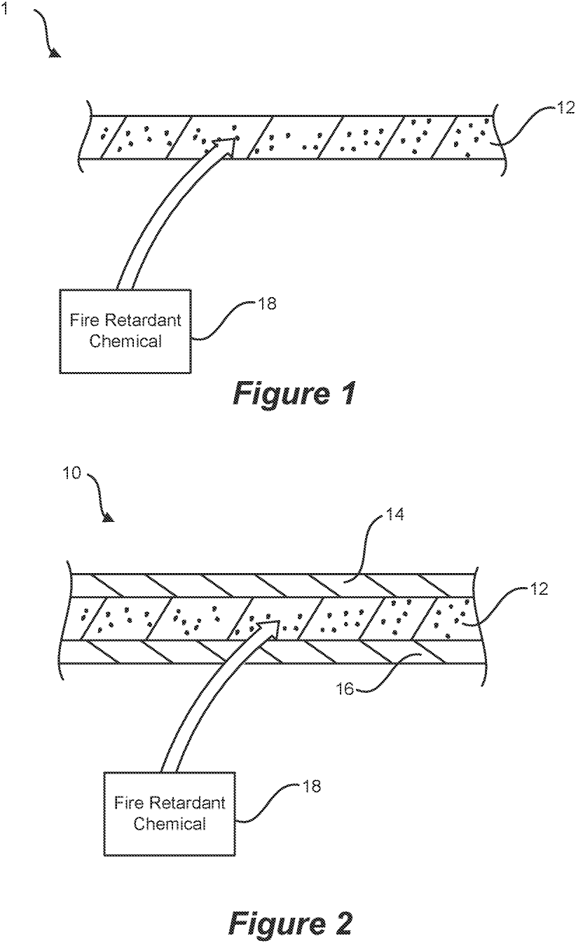

FIG. 1 shows an example of an impregnated base layer 1 that can be used for various embodiments of the fire shelter material disclosed herein. In this example, the base layer 12 is comprised of a suitable absorbent material comprising one or more of felt, white utility fabric, loosely woven fiberglass, cotton, burlap, plastic, ironing board fabric, screening, muslin, plastic foam, terry cloth, linen, wool, spandex, micro fleece, corn stalk fabric, or the like. That is to say, any fabric or other material capable of being impregnated by fire retardant chemical, and possessing minimum bulk suffices in this regard.

This base layer 12 is impregnated with a fire-resistant material 18 that can include a fire retardant chemical or other fire and/or heat resistant material that may take the form of a liquid or gel, such as a polymer combined with certain reactive flame retardant chemicals as are known in the art. Such flame or heat retardant chemicals can take the form of acrylamide, bisacrylamide, as well as an initiator and a catalyst. Also, another chemical retardant material may be added to this combination such as, a halogen compound, a phosphorous containing compound, acrylic salts, and the like. Any combination of these materials can be utilized, as desired. Reference is made to U.S. Pat. Office Publication 2003/0004247 which further specifies fire retardant materials that can be utilized to impregnate the base layer, and hence this reference is incorporated by reference herein.

The combination of the base layer impregnated with the fire resistant material can be used to form a protective portable shelter, such as a fire blanket, that provides the desired thermal insulation needed to protect an encapsulated person or thing present in a protected interior space formed by fire blanket, such as while a wildfire is traversing across the deployed location. It may be desirable to keep the fire resistant material provided in the fire blanket in a wet or gelled state, which means that either the fire resistant material is sprayed or spread onto the shelter just before or during deployment, or the shelter is initially provided in a sealed container or packaging, such as at the factory during or after manufacturing, to keep the fire resistant material from evaporating or otherwise solidifying to keep the shelter flexible and effective. Alternatively, the fire resistant material may be added to the base layer of the shelter at the time of deployment, such as by spraying, saturating, or otherwise adding to the base layer at or near the time of deployment.

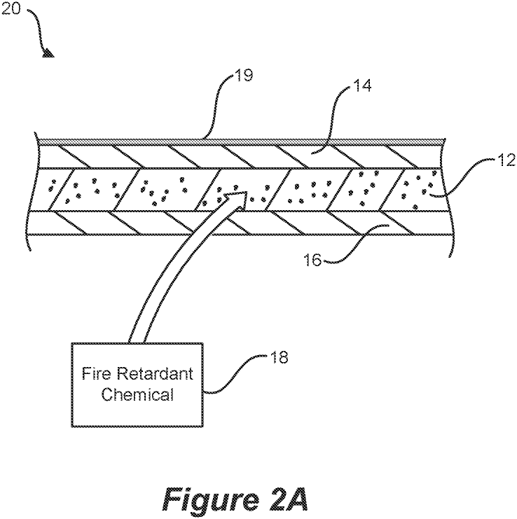

Additional layers may be added to the shelter material to provide additional features useful to form even more effective fire shelters. For example, FIG. 2 provides an example fire shelter material 10 including the impregnated base layer 12 along with two more layers 14, 16 on either side of the layer 12. The impregnated base layer 12 (such as the one shown in FIG. 1) is provided as one of its elements the base layer which is saturated with one or more of the fire retardant materials 18. The material 10 also includes an outer layer 14, such as a metallic overlayer which may provide heat reflective properties, or may be a wrapping material, used in conjunction with an inner layer 16 that can provide structure or additional heat protection, insulation, or heat reflection properties. The layers 14, 16 can also be configured to prevent the fire retardant chemical 18 from evaporating or otherwise hardening during use and/or storage.

Note that still more additional layers can be provided as desired. For example, inner layer 16 may provide structural support, outer layer 14 may provide heat reflective properties, whereas an additional outer layer 19 (as shown in FIG. 2A) can be provided to seal the entire shelter into a sealed package to prevent evaporation or hardening of the absorbed fire retardant material 18 until actual use, when the shelter is removed from the protective packaging and deployed in a fire zone. Furthermore, structural members or other components can be provided to aid in deployment of the shelter, such as framing, braces, screens, wires, or other components. Additional layers can be provided where desired.

The various layers or any subsets thereof can be laminated together using stitch bonding, glue, spot welding, or other fastening techniques.

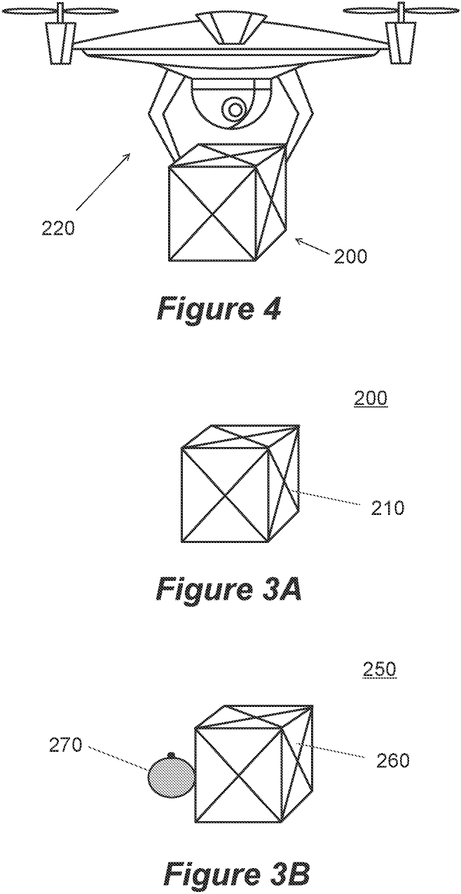

FIG. 3A shows an example of a packaged and sealed shelter package 200 containing a shelter as described herein as may be provided at, or prior to, delivery and deployment. This package 200 includes an outer packaging layer 210 that can be used to help seal the package to prevent evaporation and/or hardening of the fire retardant material found in the packaged shelter.

In the past, Firefighters often carried their ineffective fire shelters into the battle against the fire. However, this approach adds additional weight that can slow down a firefighter. A more effective strategy would be to have the packages or shelters ready for deployment as needed, such as carrying and storing with the fire vehicles, other transports, wagons, or vehicles, or carried by fire fighting aircraft, from which the packages can be delivered (e.g., dropped off) to their desired location when needed.

For example, sealed packages 200 of the proposed fire shelter can be delivered to a needed location by plane, helicopter, truck, vehicle, robot or drone. For example, the packages 200 can be dropped throughout the fire zone at regular intervals, at special meetup locations, or in advance of the fire movement to be ready for protecting fire personnel or other persons at risk.

FIG. 4 shows the example package 200 being carried by a flying drone 220 for dropping into a desired location. Any desired motive means could be utilized for transporting the shelter to a desired location, including using the traditional approach of being carried by a firefighter.

Outer packaging for the fire shelter can be removed at location to expose the shelter, the packaging can be integrated into the shelter, or the packaging can be designed to “burn off” or melt from the heat to deploy the fire shelter. For example, an outer mylar layer can be used to seal the shelter into a deployable package, and then burn off or melt to expose the shelter during deployment. Alternatively, the fire shelter can be automatically deployed using some mechanism, such as internal springs, compressed air, or a small explosive device to deploy the shelter and spread it out for use. FIG. 3B shows an example self-deploying system 250 having a sealed package 260 and a deployment device 270 attached to the package which can be deployed at request either manually, or by remote control or based on temperature readings.

The deployment device 270 might involve compressed air, a small explosive device, a spring loaded device, robotic mechanisms, chemical reactions, or any combination of these features.

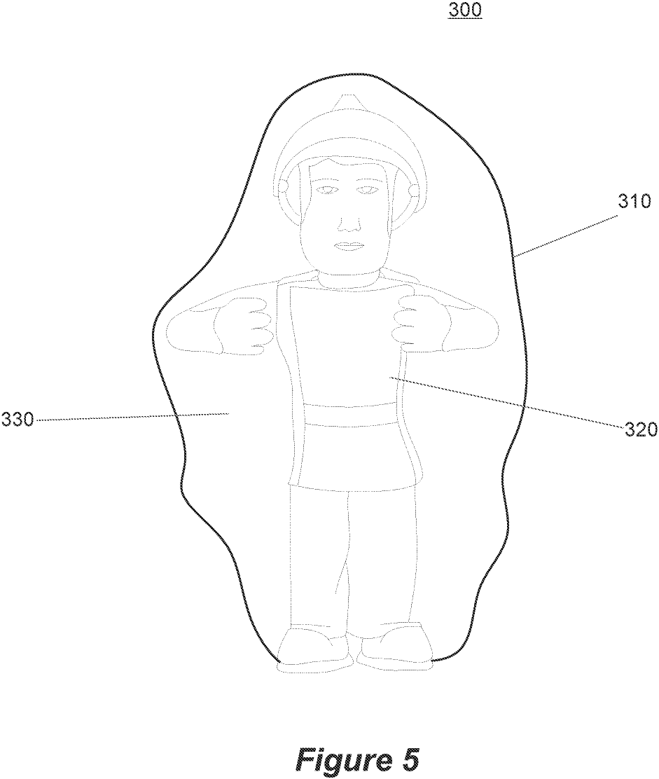

Once delivered at or near its desired location, the shelter can be deployed using various different approaches for different embodiments and situations. For example, a package may be dropped or driven by aircraft, vehicle, drone, or robot to a fireman for manual or automated deployment (or the fireman may personally carry it). FIG. 5 shows a deployed system 300 having a fire shelter 310 covering a fireman 320. The interior space 330 is kept at a safe temperature of less than 200° F. to avoid injury to the fireman 320. Note that although the drawing shows the fireman in a standing position, the fireman may crouch down under the shelter or lie down to reduce is exposure to potentially flying objects and debris.

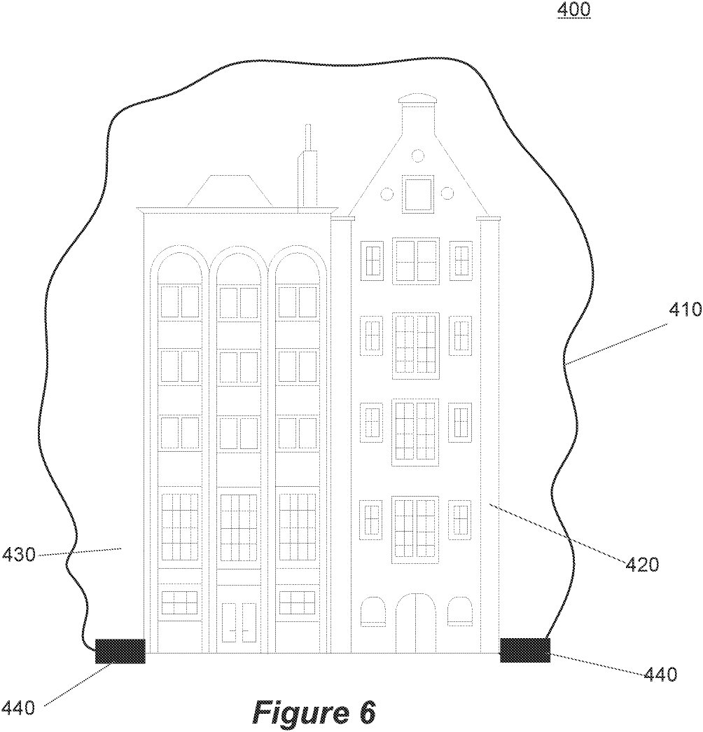

FIG. 6 shows another example deployed shelter system 400 having a large fire shelter 410 deployed to protect a building 420 from damage from fire. The interior 430 is protected from temperatures that could damage the structure and potentially lead it to combust, which may be acceptable at higher temperatures than those required to protect personnel. One or more weighted base components 440 could be utilized to help deploy the shelter 410 and keep it anchored.

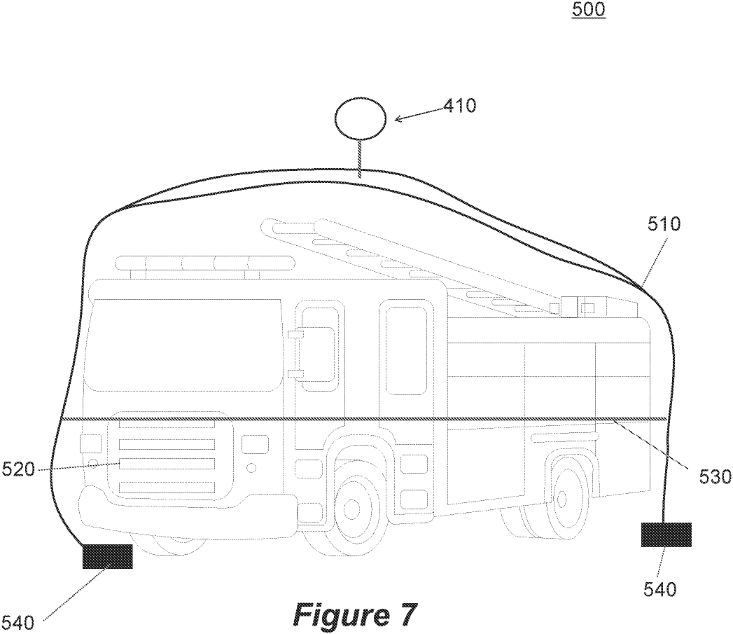

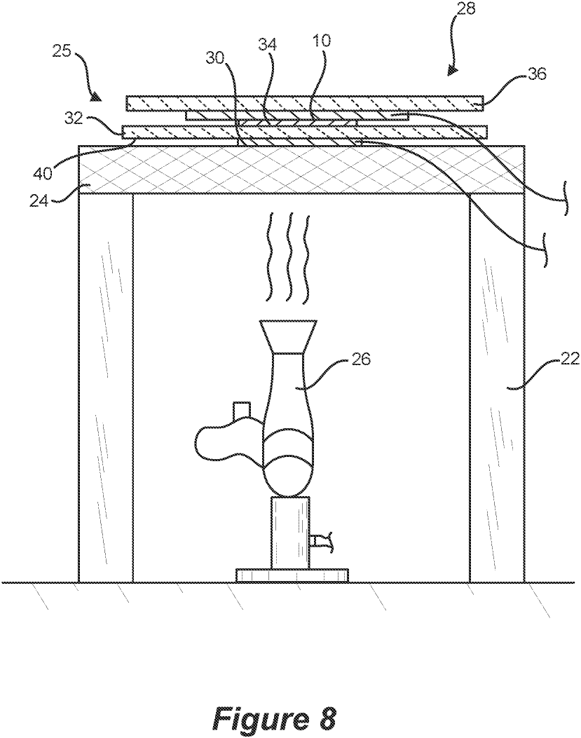

FIG. 7 shows still another deployed example shelter system 500 used to have a shelter 510 deploy to protect a vehicle 520, such as a firetruck. In this example, one or more deployment frame members 530 can be used to help spread the shelter for deployment over the vehicle 520, such as by dropping the shelter 510 from the air using the hanging structure 410 to lower the shelter 510 over the vehicle, such as by aircraft such as a helicopter or drone. Weights 540 can be used to help in the deployment and anchoring process.

Note that any of the above features and mechanisms can be used in conjunction with any of the proposed examples to improve the deployment process. The shelter material can be made sufficiently thick, or utilize one or more structural layers or other structural components, to enable the shelter to substantially hold its shape once deployed and/or to aid in deployment.

For example, the deployment process may involved spreading the shelter out prior to dropping the shelter onto the target to be protected. For example, a deployment mechanism as discussed with respect to FIG. 3B could be used to “inflate” or spread out the shelter, and one or more weights can be used with the hanging structure 410 to lower the shelter over the target object. Automatically or manually deploying frame members can also be used, or used alternatively, to spread the shelter out for deployment on the target and helping the shelter hold its shape and form the protective inner space. Various robots could be used to help deploy the shelter, in conjunction with robotic drones, for example.

FIG. 8 depicts an example apparatus 25 that can be employed in the testing of example embodiments used as the impregnated base layer 12 in fire shelter material 10. Apparatus 25 includes a stand 22 having a metallic mesh top 24. A heat source 26 (in this case a heat gun) was positioned a fixed distance from metallic mesh top 24 and sample module 28. Sample module 28 includes a first heat probe 30, a first sheet of ceramic glass 32, a second heat probe 34, fire shelter material 10, and a second sheet of ceramic glass 36. Heat source 26 was located about 7.6 cm from the bottom surface 40 of first sheet of ceramic glass 32, during testing.

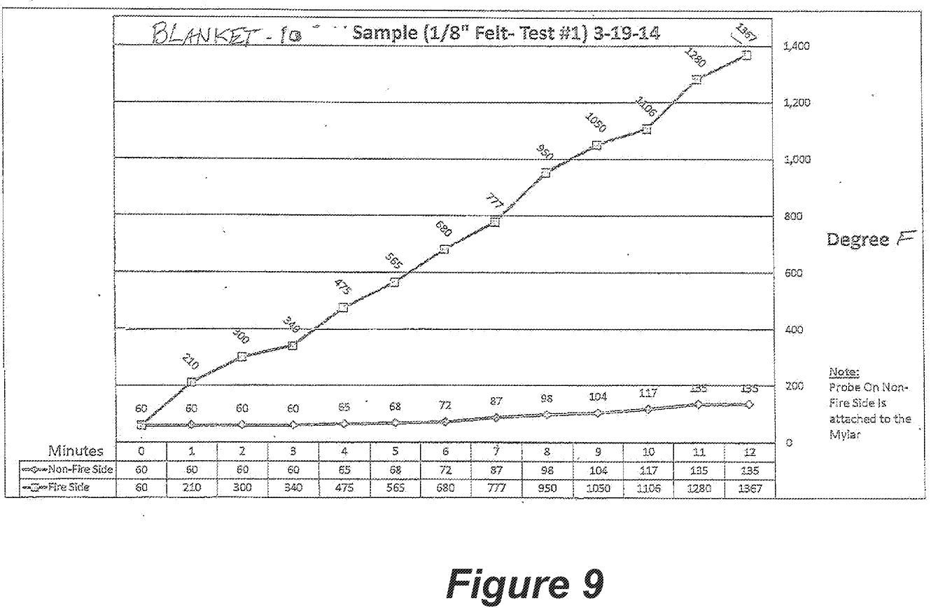

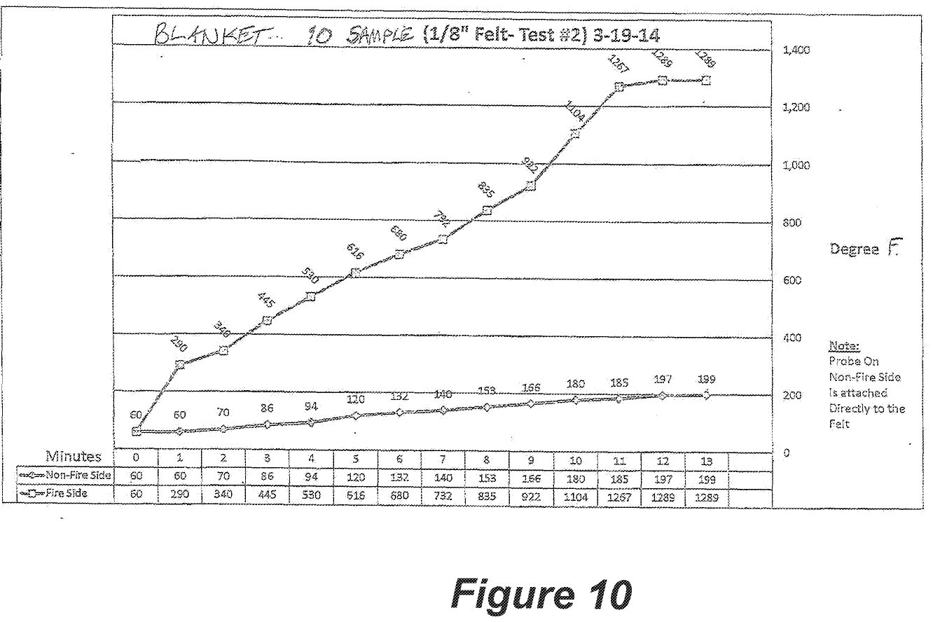

With respect to temperature plots shown in FIGS. 9 and 10, it may be observed that the blanket or structure 10 of FIG. 1, using an impregnated felt as base layer 12, was tested in this manner. As may be noted, after 12 minutes, the non-fire side of fire shelter material 10, still lay below 200° F. Such tests indicate that the fire shelter material 10 of FIG. 1 provides a far better protective environment than the prior art blankets currently in use.

The resulting fire shelter embodiments are thereby capable of withstanding temperatures of any number in the range of over 200° F. and/or to 500° F. and/or to 750° F. and/or to 1000° F. and/or to 1200° F. or above in the immediate vicinity of the fire shelter while maintaining an interior space temperature of under 200° F. for 1 minute, and/or for 2 minutes, and/or for 5 minutes, and or for 10 minutes, and/or for 12 minutes, and/or for 15 minutes or more. In particular, the interior space is protected for the typical time it takes for the fire to blow by the region where the shelter has been deployed to protect personnel, equipment, structures or any combination thereof.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A portable fire shelter comprising:
a layer of absorbent material; and
a fire resistant substance impregnating said layer of absorbent material, wherein
said fire shelter is configured to deploy in a manner to form an interior space that is protected from exceeding 200° F. for at least 15 minutes when said fire shelter is deployed in a fire environment.

2. The portable fire shelter of claim 1, further comprising packaging configured to prevent said fire resistant substance from evaporating from, or hardening within, said layer of absorbent material.

3. The portable fire shelter of claim 2, further comprising deployment structure configured to attach said shelter in said packaging to a drone aircraft.

4. The portable fire shelter of claim 2, wherein said packaging is configured to be consumed, melt, or otherwise be opened by action of the heat of said fire environment.

5. The portable fire shelter of claim 1, wherein said fire resistant substance is a liquid or gel.

6. The portable fire shelter of claim 1, said fire resistant substance including acrylamide and/or bisacrylamide.

7. The portable fire shelter of claim 1, said layer of absorbent material including felt or a woven material.

8. The portable fire shelter of claim 1, further comprising deployment structure configured to automatically deploying said fires shelter in said fire environment.

9. The portable fire shelter of claim 1, wherein said interior space is of sufficient size to encompass a building.

10. The portable fire shelter of claim 1, wherein said interior space is of sufficient size to encompass a vehicle.

11. The portable fire shelter of claim 1, further comprising a structural layer.

12. The portable fire shelter of claim 1, further comprising a heat reflecting layer.

13. The portable fire shelter of claim 1, wherein said fire environment includes a temperature greater than 1000° F. in the immediate vicinity of the deployed fire shelter.

14. A portable fire shelter comprising:
a layer of absorbent material;
a fire resistant substance in the form of a liquid or gel impregnating said layer of absorbent material; and
packaging configured to prevent said fire resistant substance from evaporating from, or hardening within, said layer of absorbent material, wherein
said fire shelter is configured to deploy in a manner to form an interior space that protects an object or person provided in the interior space from excessive heat when said fire shelter is deployed in a fire environment.

15. The portable fire shelter of claim 14, further comprising deployment structure configured to attach said shelter in said packaging to a drone aircraft.

16. The portable fire shelter of claim 14, wherein said packaging is configured to be consumed, melt, or otherwise be opened by action of the heat of said fire environment.

17. The portable fire shelter of claim 14, said fire resistant substance including acrylamide and/or bisacrylamide.

18. The portable fire shelter of claim 14, said layer of absorbent material including felt or a woven material.

19. The portable fire shelter of claim 14, further comprising deployment structure configured to automatically deploying said fires shelter in said fire environment.

20. The portable fire shelter of claim 14, further comprising a heat reflecting layer.

21. The portable fire shelter of claim 14, wherein said fire environment includes a temperature greater than 1000° F. in the immediate vicinity of the deployed fire shelter.

22. A method of providing a protected interior space in a fire environment, comprising the steps of:
providing a fire shelter comprising:
a layer of absorbent material,
a fire resistant substance in the form of a liquid or gel impregnating said layer of absorbent material, and
packaging configured to prevent said fire resistant substance from evaporating from, or hardening within, said layer of absorbent material after said impregnating,
transporting said fire shelter to a fire zone;
deploying said fire shelter in said fire zone to provide a protected space; and
maintaining a temperature within said protected space of less than 200° F. for at least 15 minutes in said fire zone.

23. The method of claim 22, wherein said transporting step is accomplished using a robot or drone.
